(19) United States
(12) Patent Application Publication
(10) Pub. No.: US 2020/0245801 A1
(43) Pub. Date: Aug. 6, 2020

(54) EXTENDABLE LOCKING DRAPERY ROD

(71) Applicant: Royal Finishing Company, Ltd., Chonburi (TH)

(72) Inventor: Wen-Chih Hsu, Chonburi (TH)

(73) Assignee: Royal Finishing Company, Ltd., Chonburi (TH)

(21) Appl. No.: 16/782,577

(22) Filed: Feb. 5, 2020

Related U.S. Application Data
(60) Provisional application No. 62/801,444, filed on Feb. 5, 2019.

(51) Int. Cl. A47H 1/022; F16B 7/14; F16B 7/04; A47H 1/02

(52) U.S. Cl. CPC A47H 1/022; A47H 2001/0215; F16B 7/042; F16B 7/14

(57) ABSTRACT

An extendable locking drapery rod including a drapery rod with a first pole defining a first pole interior; and a second pole, the second pole being insertable into the first pole interior; and a locking mechanism. The locking mechanism includes a base fixedly attached to an end of the second pole; a shoulder adjacent to the base and the end of the second pole; a neck adjacent to the shoulder having a diameter less than that of the shoulder and a neck center axis offset from a center axis of the second pole; a head with a diameter greater than that of the neck; and a clip lock. The clip lock includes a C-shaped clip adapted to rotatably fit around the neck. The neck and clip are sized so that the clip extends beyond the diameter of the shoulder and neck at all positions on the neck.

### CROSS-REFERENCE

This application claims the benefit of U.S. Provisional Application Ser. No. 62/801,444 filed Feb. 5, 2019, entitled “EXTENDABLE LOCKING DRAPERY ROD”, the entirety of which is hereby incorporated by reference.

### BACKGROUND

### Related Art

Telescoping drapery rods presently include a small-diameter pole insertable into a large-diameter pole and a locking mechanism. When the locking mechanism is unlocked, the rods may move relative to one another. When the locking mechanism is locked, there is resistance to the poles moving relative to one another. Rods of this type are limited in size by practical limitations on the lengths of the two rod segments.

Telescoping drapery rods suffer from certain deficiencies. It is common for brackets holding drapery rods to include set screws to set the rod length and prevent the curtain rod from moving horizontally. A loose fit between the telescoping poles can often cause one pole to move relative to the other when curtains or drapes are pulled open or closed. The profile of telescoping drapery rods is often inconsistent at the point where the smaller pole enters the larger pole creating a shape on which curtains or drapes will get caught when opening or closing.

### OUTLINE OF BASIC & OTHER ADVANTAGEOUS FEATURES

It would be desirable to provide a drapery rod, or the like, of a type disclosed in the present application that includes any one or more of these or other advantageous features:
That is easily adjustable in length;
That is joinable to additional rods for greater range of length;
That is easily locked into place at a chosen length; and
With a locking mechanism that is not bulky and does not interfere with the purpose of the rod for hanging curtains or drapes.

These and other features and advantages of various embodiments of systems and methods according to this invention are described in, or are apparent from, the following detailed description of various exemplary embodiments of various devices, structures, and/or methods according to the present disclosure.

### SUMMARY

An exemplary embodiment relates to a drapery rod, comprising a first pole, a second pole wherein the second pole is telescopically joinable into the first pole, and a locking mechanism, comprising a base fixedly attached to an end of the second pole, a shoulder adjacent to the base and the end of the second pole, a neck adjacent to the shoulder having a diameter less than that of the shoulder and a center axis that is different from the center axis of the second pole, a head with a diameter greater than that of the neck, and a clip lock, comprising a C-shaped clip adapted to rotatably fit around the neck wherein the neck and clip are sized so that the clip extends beyond the diameter of the shoulder and next at all positions on the neck.

These and other features and advantages of various embodiments of systems and methods according to this invention are described in, or are apparent from, the following detailed description of various exemplary embodiments of various devices, structures, and/or methods according to the present disclosure.

### BRIEF DESCRIPTION OF THE DRAWINGS

Various exemplary embodiments of the systems and methods according to the present disclosure will be described in detail, with reference to the following figures, wherein:

FIG. 1 is an exploded view of an exemplary embodiment of a drapery rod system according to the present disclosure;

FIG. 2 is an exploded view of an exemplary embodiment of telescoping drapery rod according to the present disclosure;

FIG. 3 is a perspective view of an exemplary embodiment of a twist-lock curtain rod joint according to the present disclosure;

FIG. 4 is a side plan view of the twist-lock curtain rod joint of FIG. 3 in the unlocked position;

FIG. 5 is a cross-section view of the curtain rod joint of FIG. 3 taken along the line A-A in FIG. 4;

FIG. 6 is a side plan view of the twist-lock curtain rod joint of FIG. 3 in the unlocked position;

FIG. 7 is a perspective view of an exemplary embodiment of a joint clip according to the present disclosure;

FIG. 8 is an end plan view of the joint clip of FIG. 7;

FIG. 9 is a top plan view of the joint clip of FIG. 7;

FIG. 10 is a bottom plan view of the joint clip of FIG. 7;

FIG. 11 is a perspective view of the twist-lock joint of FIG. 3 and joint clip of FIG. 7 in the unlocked position;

FIG. 12 is an end plan view of the twist-lock joint of FIG. 3 and joint clip of FIG. 7 in the unlocked position;

FIG. 13 is a perspective view of the twist-lock joint of FIG. 3 and joint clip of FIG. 7 in the locked position;

FIG. 14 is an end plan view of the twist-lock joint of FIG. 3 and joint clip of FIG. 7 in the locked position;

FIG. 15 is a perspective view of an exemplary embodiment of a connector plug according to the present disclosure;

FIG. 16 is an end plan view of the connector plug of FIG. 15;

FIG. 17 is a first side plan view of the connector plug of FIG. 15;

FIG. 18 is a second side plan view of the connector plug of FIG. 15;

FIG. 19 is a composite of an exploded view of the drapery rod system of FIG. 1, an exploded view of the connector plug of FIG. 15 and the distal ends of the first pole of the telescoping drapery rod of FIG. 2, and a side plan view of the drapery rod system of FIG. 1;

FIG. 20 is a perspective view of an exemplary embodiment of a finial plug according to the present disclosure; and

FIG. 21 is a perspective view of the finial plug of FIG. 21 with an exemplary finial aligned for connection to the finial plug.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF THE EXEMPLARY EMBODIMENTS

The present disclosure relates to a drapery rod system including one or more telescoping rod segments and/or one or more rod extensions. The telescoping sections include a twist-lock mechanism

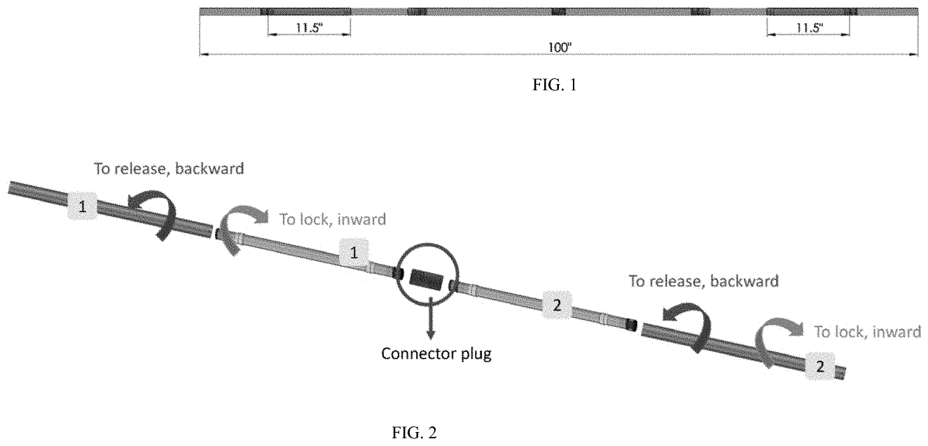

Referring to FIG. 1, an exemplary embodiment of a drapery rod system 100 includes one or more telescoping drapery rod 110. In the embodiment shown in FIG. 1, the telescoping drapery rod 110 includes two telescoping poles 111 and 116 connected by a rod connector 130. In various embodiments, the overall range of possible lengths of the drapery rod may be adjusted by eliminating one telescoping rod and/or one or both extension rods.

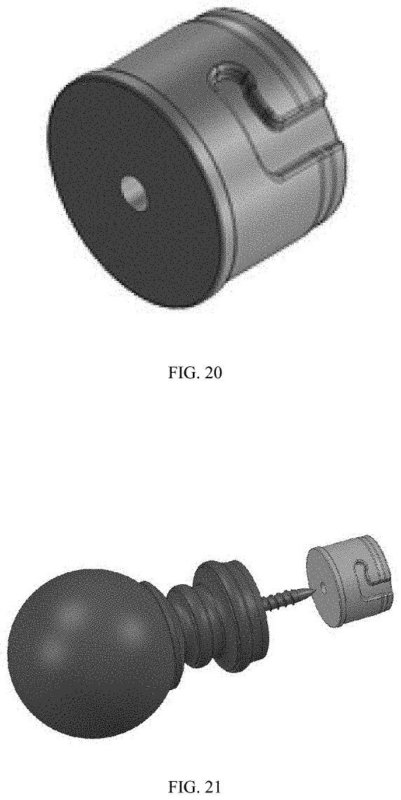

Referring to FIG. 2, an exemplary embodiment of a telescoping drapery rod 110 includes a first pole 111 having a larger diameter and a second pole 116 having a smaller diameter adapted to snugly fit telescopically into the first pole 111. The first pole 111 has a distal end 112 and a proximal end 113 wherein the proximal end 113 is adapted to receive the second pole 116. The second pole 116 is connected to a twist-lock curtain rod joint 120 at each of its ends. The distal end 112 of the second pole is adapted to connect to a connector plug 130 or finial plug 150 (see FIG. 20). In a preferred embodiment, a first pole 111 (shown in FIG. 1 but not in FIG. 2) connects the connector plug 130 to the second pole(s) 116.

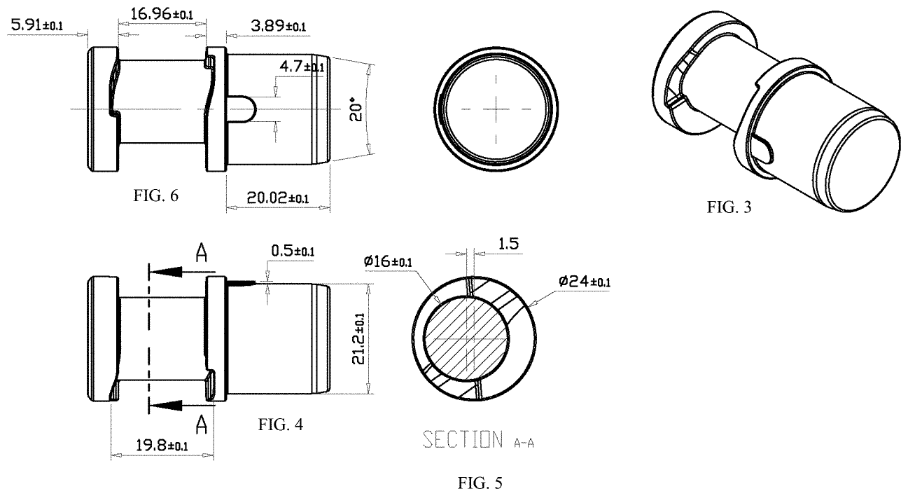

Referring to FIGS. 3-6, an exemplary embodiment of a twist-lock curtain rod joint 120 (not shown in FIG. 1 or 2) has a base 121 adapted for fixed connection to an end of the second pole 116, a shoulder 122, a neck 123, and a head or tip 124. The sides of the should 122 and head 124 each include an inwardly tapered surface 125 forming ledges 126 and 127. In an exemplary embodiment, the center axis of the neck 123 is off-center from the center axis of the base 121, shoulder 122, and head 124, as particularly shown in FIG. 5. In a preferred embodiment, the diameters of the shoulder 122 and head 124 are the same. In a preferred embodiment, a twist-lock joint 120 is fixedly attached to both ends of the inner second pole 116.

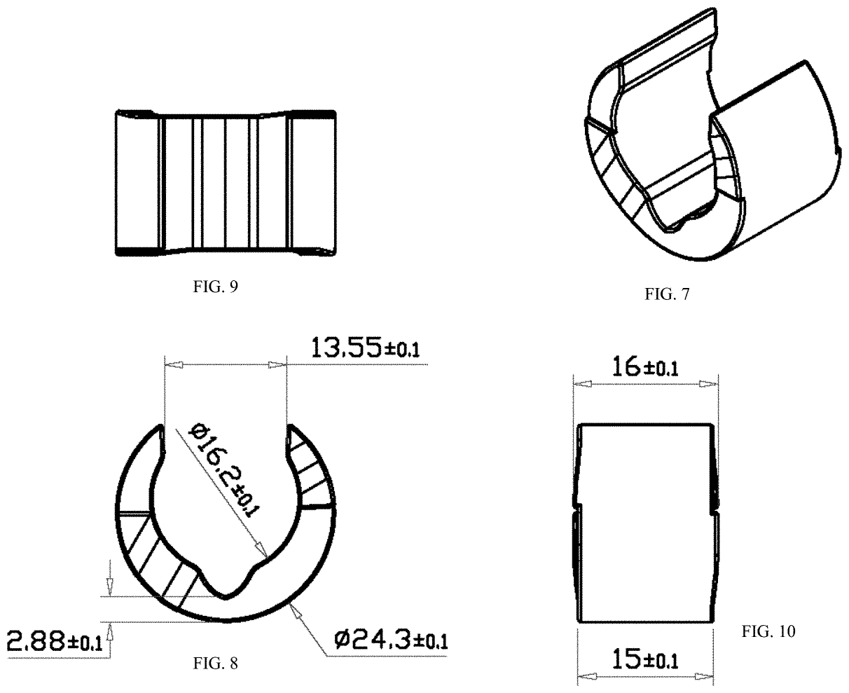

Referring to FIGS. 7-10, an exemplary embodiment of a joint clip 140 has a partial circular shape (i.e., C-shaped) adapted to fit onto the neck 123 filling the space around the neck 123 between the shoulder 122 and the head 124. It also has two outwardly tapered surfaces 141 forming tab 142 and 143.

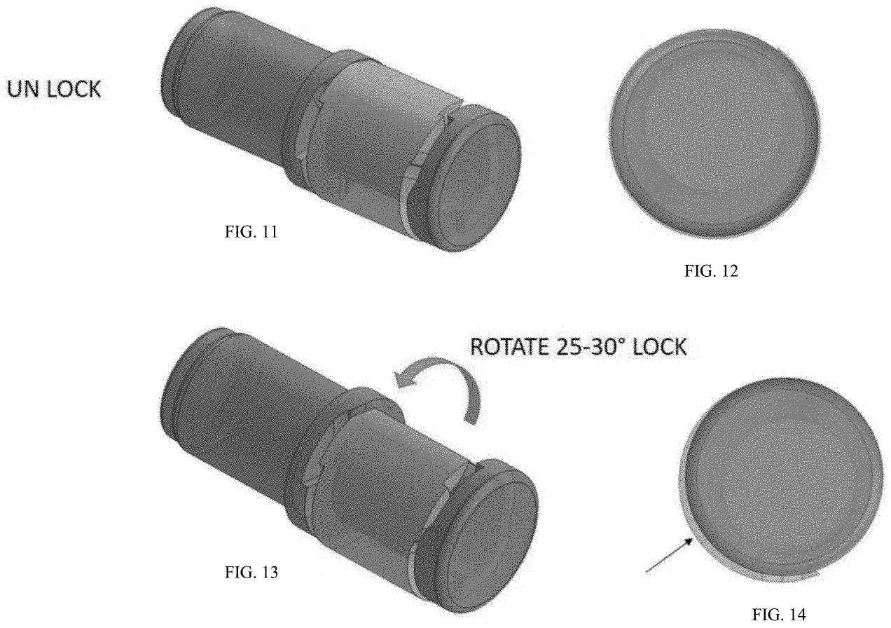

Referring to FIGS. 4-5 and 11-12, the twist-lock joint 120 and joint clip 140 are shown in the unlocked position. The joint clip 140 is placed around the neck 123 as shown in FIG. 11. Referring to FIGS. 11-12, in the unlocked position the joint clip 140 is positioned such that a second tab 143 is near or adjacent to the ledge 127 on the head 124. In a preferred embodiment, the diameter of the joint clip 140 when on the neck 123 in the unlocked position is slightly greater than the diameter of the shoulder 122 and head 124.

Referring to FIGS. 6 and 13-14, the twist-lock joint 120 and joint clip 140 are shown in the unlocked position. Referring to FIGS. 13-14, in the locked position the joint clip 140 is positioned such that a first tab 142 is near or adjacent to the ledge 126 on the shoulder 122. The other tab 143 is located away from the ledge 127 on the head. The interaction of the ledges 126 and 127 on the twist-lock joint 120 and the tabs 142 and 143 on the joint clip 140 limits the range of rotation of the respective pieces. In a preferred embodiment, this range of motion is about 25 to 30 degrees of rotation. It should be noted that the position of the ledges 126 and 127 and the tabs 142 and 143 may switched with the ledges 126 and 127 on the shoulder 122 and head 123 and the tabs 142 and 143 on the joint clip.

When the joint clip 120 is rotated to the locked position, this movement on the off-center axis of the neck 123 increases the distance from the center axis of the twist-lock joint 120 to the outer surface of the joint clip 140 pressing it against the inner surface of the first pole 111. This creates an increased frictional force between the surfaces of the joint clip 140 and the first pole 111 locking the joint clip 140 in place relative to the first pole 111 locking the twist-lock joint 120 and second pole 116 in place such that the first pole 111 and second pole 116 cannot move telescopically relative to each other.

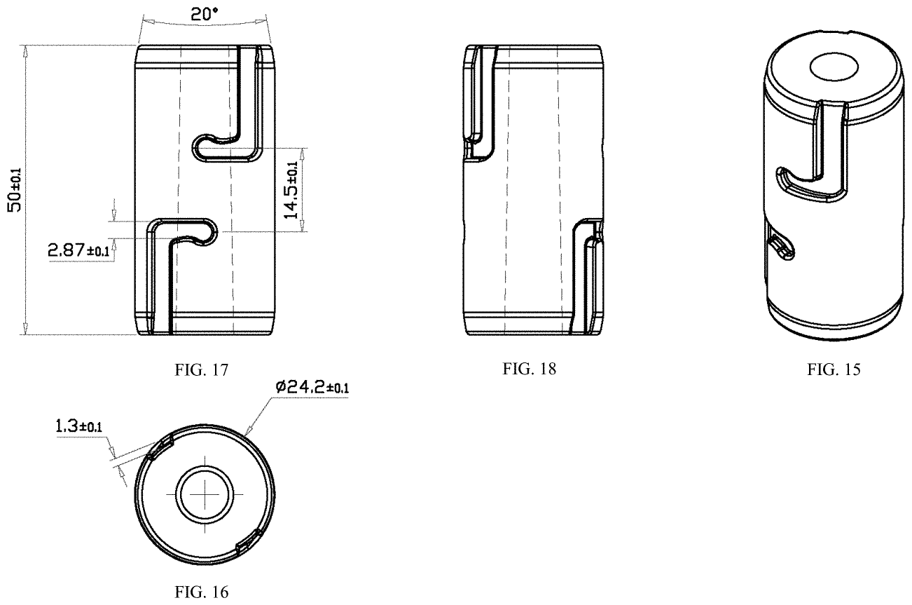

Referring to FIGS. 15-18, an exemplary embodiment of a connector plug 130 according to the present disclosure. The connector plug 130 has a conical shape and may be a hollow cylinder. The connector plug 130 has at least one L-Shaped slot 131 on each end. A preferred embodiment has two L-shaped slots 131 opposite each other on each end. The connector plug 130 is preferably adapted to connect to an end of the telescoping drapery rod 110.

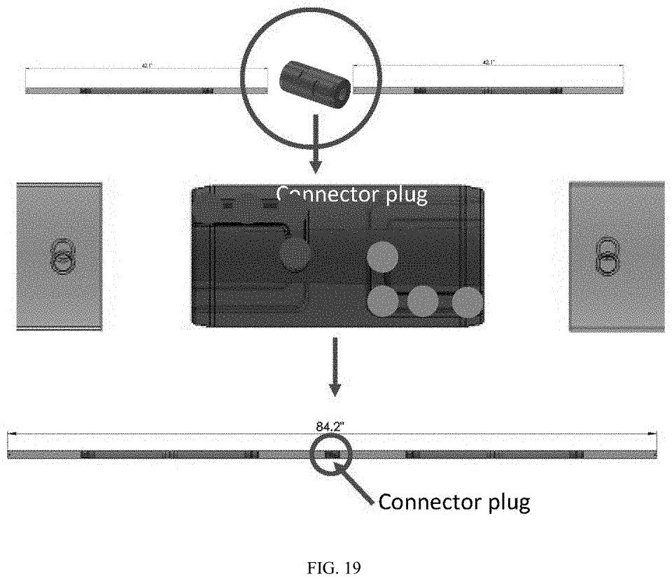

Referring to FIG. 19, an exemplary embodiment of the proximal end 113 of the wide first pole 111 has at least one guide knob 114. A preferred embodiment has two guide knobs 114 opposite each other on each end. In a preferred embodiment, the proximal end 113 is adapted to receive the rod connector 130 with the one or more L-shaped slots 131 adapted to receive the one or more guide knobs 114.

Referring to FIG. 19, the interaction of the connector plug 130 and the distal ends 112 of the first pole 111 is illustrated. The distal ends 112 include at least one knob 114. A preferred embodiment includes two oppositely positioned knobs 114. The knobs 114 and L-shaped slots 131 are adapted to interact such that when the connector plug 130 is inserted into the first pole 111, the knobs 114 enter the L-shaped slots 131. The first pole 111 and connector plug 130 are rotated in opposite directions with the knobs 114 passing down the bottom of the L-shaped slots 131 locking them in position along their axis. The knob 114 is locked in place with a detent 132 at the end of the slot 131. (See FIG. 17).

Referring to FIGS. 20-21, an exemplary embodiment of a finial plug 150 has a proximal end 151 and a distal end 152. The proximal end 151 includes at least one L-shaped slot 153.

A preferred embodiment has two L-shaped slots 153 radially opposite each other. The distal end 152 includes an indentation 154 indicating where a finial 160 may be attached to the finial plug 150. In some embodiments, the indentation 154 may be replaced with an opening adapted to receive a screw or bolt 161.

The base 121 of the twist-lock joint 120 is fixedly connected to, or an integral part of, one or both ends of the inner second pole 116. The joint clip 140 is place around the neck 123 of the twist-lock joint 120 in the unlocked position. The twist-lock joint 120, joint clip, 140 and inner second pole 116 are inserted into the outer first pole 111 to a desired position or length. The inner second pole 116 is rotated relative to the outer first pole 111 causing the twist-lock joint 120 to also rotate relative to the outer first pole 111. The joint clip 140 does not rotate relative to the outer first pole 111. As the twist-lock joint 120 and joint clip 140 rotate relative to each other, the joint clip 140 moves to the locked position. The offset neck 123 of the twist-lock joint 120 rotates and pushes the joint clip 140 against the interior surface of the outer first pole 111 creating a strong frictional force between the joint clip 140 and interior surface of the outer first pole 111.

A preferred embodiment includes two inner second poles 116 each connected to two outer first poles 111 (four total outer first poles 116) using a twist-lock joint 120 and joint clip 140 forming two curtain rod assemblies 170 (see FIGS. 1 and 2). The two assemblies 170 are connected by a connector plug 130 attached to the distal ends 112 of one of the outer first rods 111 of each assembly 170. The other ends of the assemblies 170 are capped by two finial plugs 150. An alternative embodiment includes two outer first poles 111 connected to a second inner pole 116 using a twist-lock joint 120 and joint clip 140 and two finial plugs 150.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom” or “proximal” and “distal”) in this description are merely used to identify various elements as are oriented in the figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be appreciated that the construction and arrangement of the curtain rod, as shown in the various exemplary embodiments, is illustrative only. While the curtain rod, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the curtain rod, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A drapery rod, comprising:
a first pole defining a first pole interior; and
a second pole;
wherein the second pole is insertable into the first pole interior; and
a locking mechanism, comprising:
a base fixedly attached to an end of the second pole;
a shoulder adjacent to the base and the end of the second pole;
a neck adjacent to the shoulder having a diameter less than that of the shoulder and a neck center axis offset from a center axis of the second pole;
a head with a diameter greater than that of the neck; and
a clip lock, comprising:
a C-shaped clip adapted to rotatably fit around the neck;
wherein the neck and clip are sized so that the clip extends beyond the diameter of the shoulder and neck at all positions on the neck.

2. The drapery rod of claim 1, further comprising:
a connector plug sized for insertion into the first pole;
at least one L-shaped slot at each end of the connector plug with the top of the L-shape at the end of the connector plug; and
wherein the first pole further comprises at least one knob near each end of the first pole sized to fit into the L-shaped slot when the connector plug is inserted into the first pole.

3. The drapery rod of claim 1, further comprising:
a finial plug sized for insertion into the first pole;
at least one L-shaped slot at each end of the finial plug with the top of the L-shape at the end of the finial plug; and
wherein the first pole further comprises at least one knob near each end of the first pole sized to fit into the L-shaped slot when the finial plug is inserted into the first pole.
